(19) United States
(12) Patent Application Publication
(10) Pub. No.: US 2018/0047319 A1
(43) Pub. Date: Feb. 15, 2018

(54) Unmanned Aerial Vehicle Display Method, Apparatus, and Medium

(71) Applicants: Marcela Barba, (US); Gustavo Antonio Valenzuela Rodriguez, (US)

(72) Inventors: Marcela Barba, Plymouth, MI (US); Gustavo Antonio Valenzuela Rodriguez, Plymouth, MI (US)

(21) Appl. No.: 15/675,708

(22) Filed: Aug. 12, 2017

Related U.S. Application Data
(60) Provisional application No. 62/374,407, filed on Aug. 12, 2016.

(51) Int. Cl. G09F 21/06; G09F 19/18; G03B 21/20; G09F 13/22; G09F 13/00; G03B 21/56; B64C 39/02; G09F 13/02

(52) U.S. Cl. CPC G09F 21/06; B64C 39/024; G09F 19/18; G09F 13/02; G09F 13/22; G09F 13/005; G03B 21/565; G03B 21/2033; B64C 2201/12; G09F 2013/222

(57) ABSTRACT

An advertising apparatus comprises an unmanned aerial vehicle (UAV) having at least one motor, and at least one propeller operably connected to said at least one motor for providing vertical lift to said UAV, and a three-dimensional advertising assembly operably attached to said UAV, said advertising assembly comprising a display medium for providing a non-planar, viewable display for conveying at least one image to a viewer.

### RELATED APPLICATIONS

This patent application claims the benefit of U.S. Provisional Patent Application Ser. No. 62/374,407 filed Aug. 12, 2016 and entitled “UNMANNED AERIAL VEHICLE DISPLAY METHOD, APPARATUS, DEVICE, AND MEDIUM”, the disclosure of which is incorporated herein by reference in its entirety.

### FIELD OF THE INVENTION

The present invention is directed to an unmanned aerial vehicle (UAV), and more particularly to an unmanned aerial vehicle for displaying images, information, and advertising.

### BACKGROUND

The use of UAVs for commercial purposes is growing. There are currently UAVs in use as spectacles for entertainment, such as with Disney's “flixels”, or floating pixels. Similarly, UAVs have been used to carry two-dimensional light emitting diode (LED) signs with one or more drones for aerial advertising purposes. Drones have also been used to carry flags or figures substantially beneath a UAV. While these methods and devices may fulfill particular objectives and requirements, their use is limited. Because the display or other object is suspended from the UAV, hanging substantially below the UAV, the UAV has little control over the object's movement and can easily lose control due to naturally occurring wind, or from the movement of the UAV. The result of the movement causes the object suspended to move like a pendulum side to side, and forwards and backwards and spin unwieldly, or can in some instances even cause the drone to crash. This uncontrolled movement impedes the ability of the operator on the ground from accurately flying, or otherwise controlling the UAV. Furthermore, where the UAV payload is for example for a projected image, as the UAV moves and the wind blows, the projected image will move in an inconsistent manner, resulting in a distorted or improperly projected image.

Moreover, being suspended below the UAV, it is necessary for the UAV to take off or land in a substantially large and clear open area to avoid the object from colliding with objects on the ground or risking collisions with buildings, or overhead lines, damaging both property and the UAV and its payload. Therefore, it can be appreciated that there exists a continuing need for a new method for aerial advertising that is more fully controllable and stable. Accordingly, it would be advantageous to have a UAV for advertising that is less impacted by environmental forces, more easily controllable, and can take-off and land in more confined areas, while minimizing the risk of damage to the UAV and/or objects on the ground.

### SUMMARY

In one embodiment, there is provided an advertising apparatus comprising an unmanned aerial vehicle (UAV) having at least one motor, and at least one propeller operably connected to the at least one motor for providing vertical lift to the UAV, and an advertising assembly operably connected to the UAV, the advertising assembly comprising a display medium for providing greater than 180 degrees of viewable display, for conveying at least one image to a viewer. The display medium may be a permeable material for reducing the effect of wind on the advertising apparatus to provide greater flight control of the advertising apparatus. The advertising assembly may further comprise a cylinder, such that said display medium provides up to 360 degrees of viewable display. There may be a projector mounted to the UAV for projecting at least one image on the display medium. The projector can project a still image, a plurality of still images, or video image on the display medium. Alternatively, the at least one image can be imprinted on the display medium. There may be at least one light for illuminating the imprinted image on the display medium. There may also be a processor, used to control the displayed image. The display medium may comprise LEDs for displaying the at least one image. The processor may also be used to control the LEDs for displaying a plurality of still images, as well as for displaying a video image.

In another embodiment, there is provided an advertising apparatus comprising an unmanned aerial vehicle (UAV) having at least one motor, and at least one propeller operably connected to said at least one motor for providing vertical lift to said UAV, and a three-dimensional advertising assembly operably attached to said UAV, wherein the advertising assembly comprises a display medium for providing a non-planar, viewable display for conveying at least one image to a viewer.

### BRIEF DESCRIPTION OF THE DRAWINGS

The foregoing and other objects, features and advantages of embodiments of the present inventions will be apparent from the more particular description of preferred embodiments, as illustrated in the accompanying drawings in which like reference characters refer to the same elements throughout the different views in which:

FIG. 1 is a perspective view of the advertising UAV according to the present invention;

FIG. 2 is an upper angled view of the advertising UAV of FIG. 1 using a projector to display an image; and

FIG. 3 is a perspective view of another embodiment of the advertising UAV according to the present invention using LEDs to display an image.

### DETAILED DESCRIPTION

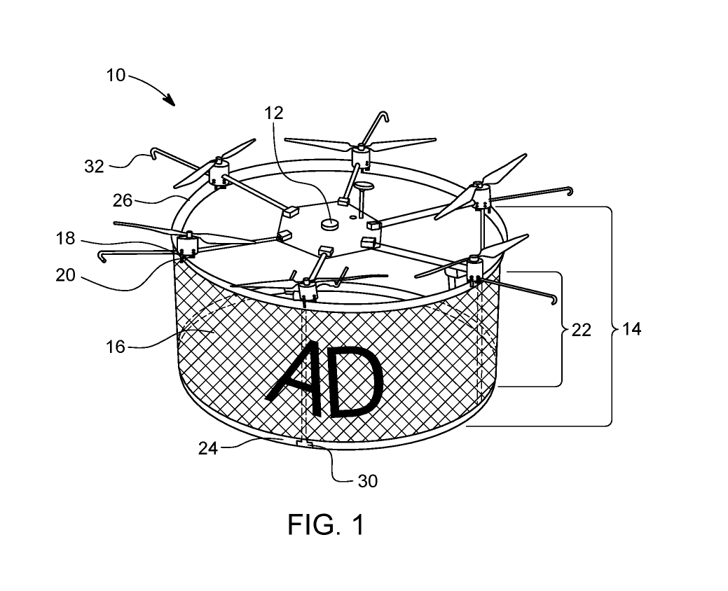

There is shown in FIG. 1 an unmanned aerial vehicle (UAV) advertising apparatus 10 according to an embodiment of the present invention comprising a UAV 12 integrated with an advertising assembly 14 having a display medium 16. Although not required, display medium 16 may be, for example, an air-permeable, or mesh fabric material to minimize impact from the wind, as well as to provide more efficient movement through the air without distorting display medium 16, while also making display medium 16 lighter. Similarly, display medium 16 may comprise any material which can be supported by a sufficiently powered UAV.

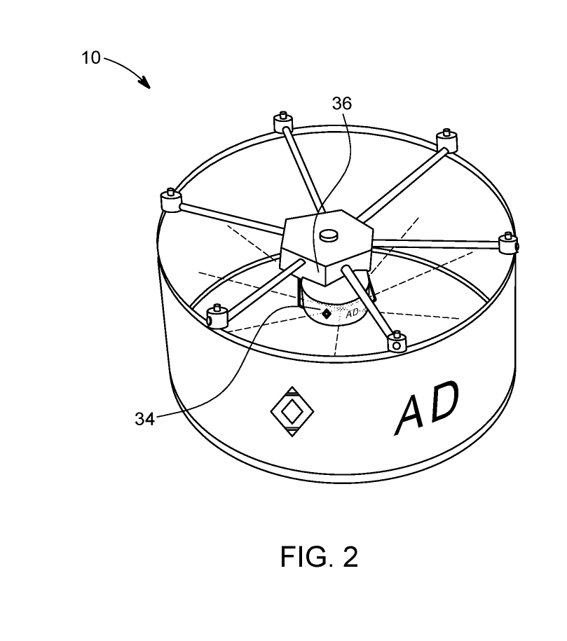

Display medium 16 may have one or more images or advertisements imprinted on it such as, for example, a product name, company name, business service, or upcoming event. Thus, the lighter the display medium 16 is, the longer the flight time and thus the greater the advertising time. Alternatively, as discussed in more detail in reference to FIG. 2, display medium 16 may comprise a projection screen where at least one projector 34 mounted on UAV 12 casts a static, alternating, or moving image on display medium. 16 The projection may cover up to the full 360 degrees of the apparatus and the desired effect could be achieved with any kind of projection technology well known in the art. The projector may also connect to a processor for image changing.

Advertising assembly 14 may attach to the UAV 12 by way of a device 18 equipped with a clamping mechanism to connect and disconnect the assembly from the UAV. This device enhances the portability of the advertising apparatus 10. There may also be provided a safety mechanism 20 that is included on the device 18 between UAV 12 and advertising assembly 14 in the event assembly 14 needs to be released from UAV 12. Safety mechanism 20 may comprise a spooled, or coiled line that lowers advertising assembly 14 in an emergency, suspending it from UAV 12, without completely releasing it for safety reasons, to permit control of UAV 12 while minimizing the risk of damage to both UAV 12 or assembly 14.

Advertising assembly 14 may comprise a three-dimensional display assembly 22, for example shown here as a 360-degree cylindrical display assembly, upon which display medium 16 is mounted. However, display assembly 22 may comprise less than 360 degrees of viewable display, and may be for example triangular, or some other non-planar shape. This not only provides great view ability, but aids in the overall aerodynamics while providing a stable viewing platform. Display Assembly 22 comprises a lower support 24 and an upper support 26 connected by a plurality of vertical supports 28. Lower support 24 and upper support 26 may be of a flexible material, for example carbon fiber rods, fiberglass rods, or the like, that are light weight yet strong enough to bear the weight of medium 16 without sagging, and in fact can stretch medium 16 taut to prevent or minimize wrinkles. Due to the flexible nature of medium 16, while shown as parallel rings to form a cylinder, upper and lower supports 26 and 24, respectively, may take various three dimensional geometric shapes such as triangles, rectangles, hexagons, etc.

Vertical supports 28 may be permanently attached to lower and upper supports 24 and 26, respectively, or removably attached with connectors 30, for example a T-connector, thereby allowing the size of display medium 16 to be increased or decreased to accommodate a particular advertisement, or display image, as well as providing easier portability of UAV advertising apparatus 10. Vertical supports 28 may also be longer than display medium 16 is tall to ensure sufficient tension to stretch display medium taut to avoid wrinkles in display medium 16. Additionally, vertical supports 28 may extend beyond lower support 24 to also provide a landing support so that display medium 16 does not contact the ground when advertising UAV 10 is landing, obviating the need for separate landing gear and keeping the advertising apparatus light, thereby prolonging flight time.

Display medium 16 may be attached to display assembly 22 by zippers that run parallel and adjacent to lower and upper rings 24 and 26. Alternatively display medium 16 may be attached using hook and loop fasteners such as Velcro®, a friction fit, a press and seal channel connection, or other means of fastening well known in the art. There may be further provided one or more lights 32 for illuminating display medium 16 at night or in low light, for example when the image or advertisement is imprinted on medium 16, or to act as navigational lights, e.g., red and green to indicate direction of travel.

Referring now to FIG. 2, advertising UAV 10 may further comprise at least one projector 34 mounted to UAV 12 for retro-projecting an image, advertisement or video image onto display medium 16. There may also be a processor 36 to control the image projected such that it encompass the full 360 degree space. Retro projecting onto advertising medium 16 from an apparatus mounted directly to UAV 12 provides a stable image on display medium 16 because the distance between the projector(s) and the material being projected upon remains unchanged, regardless of how the UAV moves, creating a clearer image which allows for increased legibility and advertising indicia recognition.

Moreover, allowing an operator to provide multiple images, or advertisements without having to land the UAV and physically change the display medium to a different display medium carrying a different image or advertisement allows an operator to make the most efficient use of the UAV's flight time. That is, by using a projector, an operator may display multiple advertisements for multiple products either from the same vendor, or multiple different advertisements from multiple different vendors, and charge advertisers for the amount of time their ads are displayed during any given flight, thereby maximizing operating time and advertisement revenue, avoiding the need to land and change static advertisements.

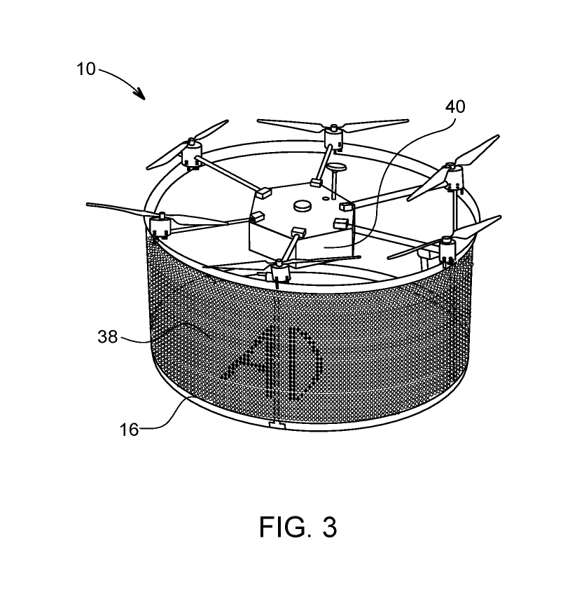

Referring now to FIG. 3, there is shown another embodiment of our advertising assembly 10 according to the present invention. In this embodiment display medium 16 may further comprise of LEDs to display at least one image. OLEDs may also be used. LEDs provide increased visibility at greater distances during the day and even greater distances at night. Display medium 16 may comprise of one or more rigid or flexible LED panels or LED mesh 38, for increased wind tolerance and lighter weight as similarly discussed above. Display medium 16 may further comprise discrete LEDs, either of a single color, or, for example, RGB LEDS which provide color changing functionality to display a wide variety of images and video. Changing or moving images are controlled by a processor 40 which conveys information store in memory to be displayed. As with the projector 34 described above, the use of LEDs with display medium 16 allows for the display of different images or video from different advertisers for different lengths of time, thereby permitting pay-per-second advertising. The ability to display multiple advertisements from different vendors allows the accommodation of more clients can be promoted within a given time frame. Allowing clients to advertise for longer or shorter periods of time, permits more access to customer bases by broadening the range of prospective advertisers, i.e., small businesses that cannot afford to pay a lot, as well as larger businesses that can afford longer ads. This further allows an operator to maximize flight time and revenue by being able to display ads throughout an entire flight with appropriately timed ads.

Having thus described several aspects of various embodiments of the present invention, it is to be appreciated various alterations, modifications, and improvements will readily occur to those skilled in the art without diverging from the scope of the present invention. Such alterations, modifications, and improvements are intended to be part of this disclosure, and are intended to be within the spirit and scope of the inventions. Accordingly, the foregoing description and drawings are by way of example only.

What is claimed is:

1. An advertising apparatus comprising:
an unmanned aerial vehicle (UAV) comprising at least one motor, and at least one propeller operably connected to said at least one motor for providing vertical lift to said UAV; and
an advertising assembly operably attached to said UAV, said advertising assembly comprising a display medium for providing greater than 180 degrees of viewable display, for conveying at least one image to a viewer.

2. The advertising apparatus of claim 1 wherein said display medium further comprises a permeable material for reducing the effect of wind on said advertising apparatus to provide greater flight control of said advertising apparatus.

3. The advertising apparatus of claim 1 wherein said advertising assembly further comprises a cylinder, such that said display medium provides 360 degrees of viewable display.

4. The advertising apparatus of claim 1 further comprising at least one projector for projecting at least one image on said display medium.

5. The advertising apparatus of claim 4 wherein said projector(s) projects a video image on said display medium.

6. The advertising apparatus of claim 1 wherein said at least one image is imprinted on said display medium.

7. The advertising apparatus of claim 6 further comprising at least one light for illuminating said display medium.

8. The advertising apparatus of claim 1 further comprising a processor for controlling said at least one image.

9. The advertising apparatus of claim 8 wherein said display medium comprises LEDs for displaying said at least one image.

10. The advertising apparatus of claim 9 wherein said processor controls said LEDs for displaying a plurality of images.

11. The advertising apparatus of claim 9 wherein said processor controls said LEDS for displaying a video image.

12. An advertising apparatus comprising:
an unmanned aerial vehicle (UAV) comprising at least one motor, and at least one propeller operably connected to said at least one motor for providing vertical lift to said UAV; and
a three-dimensional advertising assembly operably attached to said UAV, said advertising assembly comprising a display medium for providing a non-planar, viewable display for conveying at least one image to a viewer.
